(19) United States
(12) Patent Application Publication
(10) Pub. No.: US 2009/0091469 A1
(43) Pub. Date: Apr. 9, 2009

(54) Control device to actuate electrical functions of an automobile by a handicapped driver

(76) Inventor: Martine Kempf, Sunnyvale, CA (US)

Correspondence Address: MILDE & HOFFBERG, LLP, 10 BANK STREET, SUITE 460, WHITE PLAINS, NY, 10606, US

(21) Appl. No.: 11/973,405

(22) Filed: Oct. 9, 2007

(51) Int. Cl. G06F 19/00

(52) U.S. Cl. 340/825.19

(57) ABSTRACT

The invention relates to a control device having control channels to actuate various electrical functions of an automobile by a handicapped driver. A rotator grip is mounted on the steering wheel (1) of the automobile so that it may rotate with respect to the steering wheel (1) to actuate the steering wheel (1) by the handicapped driver. An encoder (10) containing the control channels is affixed to the rotator grip (2) so that it may not rotate. An electronic circuit of the encoder (10) is assigned to each control channel so that, upon actuation of the control channel assigned to it, an individual signal corresponding to the control channel is created that is transferred via an antenna (7) of the encoder (10) to another antenna (8) of a decoder (14) that evaluates the individual signal in order to perform the corresponding function.

### BACKGROUND OF THE INVENTION

The invention relates to a control device to actuate electrical functions of an automobile by a handicapped driver.

It is known to mount control devices to actuate electrical functions of an automobile on the steering wheel of the automobile of handicapped persons. For example, a rotator knob may be affixed to the steering wheel for one-armed drivers so a one-armed driver can grasp it to rotate the steering wheel. Control channel switches may be provided within reach of the fingers by means of which a one-armed driver can actuate the following twelve functions: horn, flash high-beam headlights, lights on/off, low-beam/high-beam headlights, turn signals left/right, warning flashers, raise/lower left window, windshield wiper front, windshield wiper rear, intermittent windshield wiper, low-speed windshield wiper, and high-speed windshield wiper. These functions are usually controlled using six pressure switches, whereby some pressure switches are specially actuated by repeated pressing or by longer actuation or suppression times. As necessary, the control channel switches are attached under the rotator knob either to the right or to the left (at the clock hour-hand positions of 2 o'clock or 10 o'clock). The known control device includes an encoder and a decoder mounted on the steering wheel and a decoder mounted on the instrument panel along with the above-mentioned pressure switches. Relays within the decoder control each electrical function of the automobile. Pressing a pressure switch causes the encoder to transmit a voltage signal assigned to the pressure switch to the decoder via a two-conductor cable, whereby one lead may be grounded to the vehicle chassis. The decoder analyzes this individual voltage signal and activates the corresponding relay whose main leads are electrically connected to a control element for the corresponding function of the automobile.

The encoder mounted on the steering wheel essentially consists of an electronic circuit board with the above-mentioned six pressure switches, six resistors, and a light-emitting diode (LED). As mentioned, the encoder is connected with the decoder via a two-conductor cable so that, when no pressure switch is pressed, a voltage signal of 4.4 volts (V), for example, is present in one conductor but 0 V is present in the other conductor. Pressing a pressure switch causes a voltage drop in the voltage signal. These voltages may be sub-divided into 0 V, 1 V, 1.9 V, 2.6 V, 3.1 V, and 3.9 V. In order to ensure signal transfer from the steering wheel to the decoder, the two conductors of the wrapped spring used to create the horn signal are used in a conventional fashion. Horn actuation at the steering wheel remains unchanged, and is connected in parallel to the horn switch of the control device.

A signal processor of the decoder located on the instrument panel monitors the voltage signal from the encoder. When the voltage changes, the decoder analyzes which pressure switch was pressed, and for how long, based on the above-mentioned voltage levels. Depending on programming, it then actuates one or more relays based on the received voltage levels to perform a function of the automobile.

A problem with this known control device is that a one-armed driver must hold the rotator grip to steer the automobile with his only hand, whereby the rotator grip is free to rotate. This may lead to displacement between the pressure switches and the rotator knob. It is therefore difficult when negotiating a traffic circle to press the correct pressure switch, for example to find the function: left-right turn signal because the orientation of the control device is displaced by 180°, and the right turn signal switch is now to the left of the left turn signal switch, for example.

The objective of the invention is to improve a control device of the type described above so that unproblematic actuation of the pressure switches is possible.

This objective is achieved, in accordance with the present invention, by providing a control device that uses control channels to actuate the electrical functions of an automobile by a handicapped driver. A rotator grip is mounted on the steering wheel of the automobile so that it may rotate with respect to the steering wheel to actuate the steering wheel by the handicapped driver. An encoder containing the control channels is affixed to the rotator grip so that it may not rotate. An electronic circuit of the encoder is assigned to each control channel so that, upon actuation of the control channel assigned to it, an individual signal corresponding to the control channel is created that is transferred via an antenna of the encoder to another antenna of a decoder that evaluates the individual signal in order to perform the corresponding function.

The essential advantage of the control device according to the invention is that it is ensured that the encoder rotates along with the rotator grip so that the orientation between the fingers of the hand of a one-armed driver holding the rotator grip and the pressure switches of the encoder remain upright during steering maneuvers. Dangerous situations and improper actuations may thus be prevented.

Another advantage of this control device is that it requires no battery because of the use of RF-ID technology, so that failure of the electrical functions, which may occur if the battery is discharged, is prevented. Thus, operating reliability of the automobile is further increased. Additionally, elimination of the battery avoids unnecessary increase in weight on the steering wheel. Additional weight may cause the power steering system to pull slightly to one side or the other.

It is advantageously ensured that this control device operates only in the low frequency range, e.g., at 134.2 kHz, i.e., below 1 MHz. Thus, European Guidelines EG 75/54 are obeyed.

For a full understanding of the present invention, reference should now be made to the following detailed description of the preferred embodiments of the invention as illustrated in the accompanying drawings.

### BRIEF DESCRIPTION OF THE DRAWINGS

FIG. 1 lateral view of a control device based on the invention mounted on a steering wheel.

FIG. 2 top view of the control device based on the invention from FIG. 1.

FIG. 3 a circuit diagram to explain the principle of this invention.

### DESCRIPTION OF THE PREFERRED EMBODIMENTS

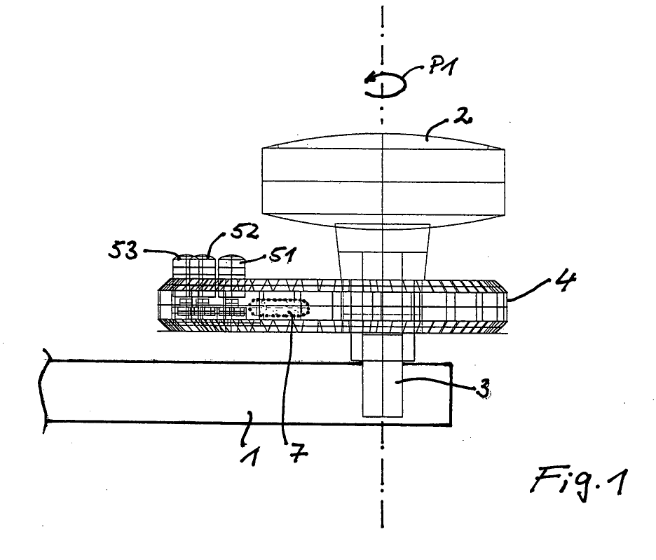

The preferred embodiments of the present invention will now be described with reference to FIGS. 1-3 of the drawings. Identical elements in the various figures are designated with the same reference numerals.

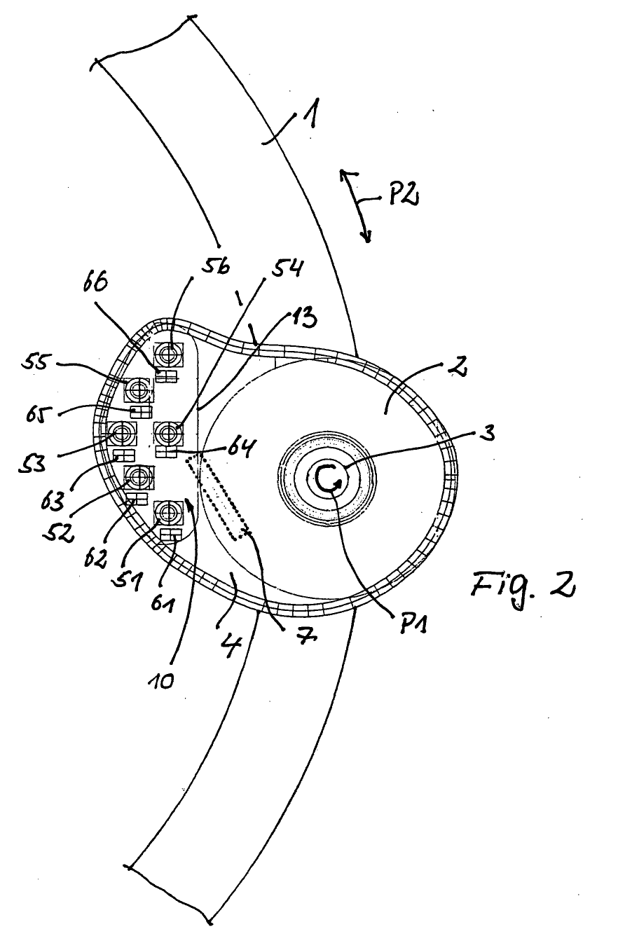

FIG. 1 shows this control device mounted on the steering wheel 1 of an automobile. It basically includes a rotator knob or rotator grip 2 to which an axis 3 is attached that is mounted on the steering wheel 1 so that the axis may rotate. Thus, the rotator grip 2 corresponds to the conventional rotator grip described at the outset to actuate an automobile steering wheel by a one-armed driver. A carrier part 4, preferably a plate-shaped component, is mounted onto the axis 3 so that the carrier part 4 cannot rotate. Six control channels are located on the carrier part 4, preferably six control-channel or pressure switches 51, 52, 53, 54, 55, and 56, as FIG. 2 shows well. The above-mentioned pressure switches are components of the encoder 10 mounted on the carrier part 4 which in turn is positioned on a circuit board attached to the carrier part 4.

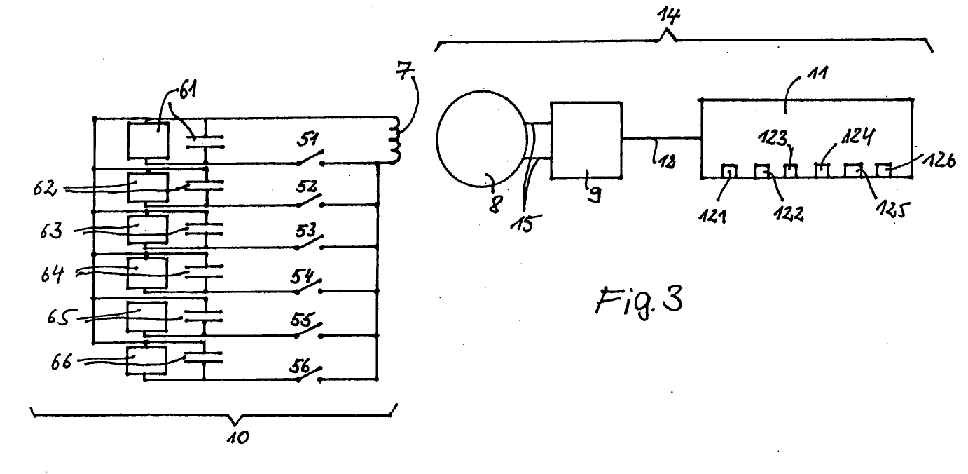

Further, the encoder 10 advantageously includes six differently-coded electronic circuits, preferably six differently-coded passive RF-ID tags 61, 62, 63, 64, 65, and 66, to each of which a specific pressure switch 51, 52, 53, 54, 55, or 56 is assigned. Each RF-ID tag is connected in series to the pressure switch assigned to it, and may, per FIG. 3, form a closed current circuit with the antenna 7 of the encoder 10 when the pressure switch is pressed. It is thus achieved that, when a pressure switch 51, 52, 53, 54, 55, or 56 is actuated, the RF-ID tag assigned to it is connected with the antenna 7.

Each RF-ID tag 61 through 66 may send an individual signal based on its coding to the antenna 7 upon actuation of the pressure switch assigned to it that contains individual digital information depending on the actuation of a specific pressure switch.

The individual signal transmitted from the antenna 7 is transferred to a main antenna 8 connected with a decoder 9 that in turn is connected to a control unit 11 via an interface 12, said control unit 11 containing relays 121, 122, 123, 124, 125, 126 that are actuated corresponding to the individual signals received from the main antenna 8 in order to perform a specific automobile function. For example, at least six relays 121, 122, 123, 124, 125, 126 are provided to perform the six functions. It must be mentioned that it may be advantageous to provide not just one relay, but rather several relays, for specific functions. The above-mentioned elements 8, 9, 11, 12, and 121 through 126 are components of a decoder 14 preferably mounted on the automobile instrument panel.

During operation, the decoder 14 transmits intermittent power signals via the main antenna 8 as necessary. Upon actuation of a pressure switch 51 through 56, the power signal to charge the capacitor of the RF-ID tag corresponding to the actuated pressure switch is next transferred via the antenna 7 and the actuated pressure switches to the capacitor. As soon as the capacitor possesses enough current, the RF-ID tag transmits its digital code as an individual signal via the antenna 7 to the main antenna 8, which in turn transmits this code to the decoder 9 and to the control unit 11 that actuates at least one relay 121, 122, 123, 124, 125, or 126 corresponding to the code.

Since the rotator grip 2 may be rotated freely with respect to the steering wheel 1 (Arrow P1), since the carrier part 4 is coupled with the encoder 10 or with the plate 13 so that it may not rotate, the orientation of the pressure switches 51 through 56 with respect to rotator grip 2 remains constant. The spatial assignment of the pressure switches 51 through 56 to the rotator grip 2 does not change, so that no operating problems may arise that may be attributed to a change in position of the pressure switches 51 through 56 with respect to the rotator grip 2.

The connection between the main antenna 8, mounted for example on the steering wheel, and the decoder 9, mounted for example on the instrument panel, is provided via a wire connection 15, preferably via the two conductors of the wrapped spring provided by the automobile manufacturer for the horn signal. Horn operation on the steering wheel 1 thus remains intact, and is connected in parallel to the pressure switches provided for the horn function.

It must be mentioned that the main antenna 8 may also be positioned at other locations within the automobile that are within reception range of the antenna 7. For example, the antenna 8 may also be located on the automobile instrument panel or below the roof.

There has thus been shown and described a novel control device to actuate electrical functions of an automobile by a handicapped driver which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. Control device to actuate electrical functions of an automobile by a handicapped driver using control channels to actuate the functions and with a rotator grip mounted on the steering wheel of the automobile so that it may rotate with respect to the steering wheel to actuate the steering wheel by the handicapped driver,
wherein
an encoder containing the control channels is affixed to the rotator grip so that it may not rotate; and
an electronic circuit of the encoder is assigned to each control channel that, upon actuation of the control channel assigned to it, an individual signal corresponding to the control channel is created that is transferred via an antenna of the encoder to another an additional antenna of a decoder that evaluates the individual signal in order to perform the corresponding function.

2. Control device as in claim 1, wherein the encoder is mounted on a carrier part connected to the rotator grip so that the carrier part may not rotate.

3. Control device as in claim 2, wherein the carrier part is plate-shaped.

4. Control device as in claim 1, wherein the control channels are pressure switches.

5. Control device as in claim 1, wherein the electronic circuit includes a passive RF-ID tag that generates an individual digital code as an individual signal.

6. Control device as in claim 5, wherein each RF-ID tag is connected in series with a pressure switch; and wherein each series circuit that comprises an RF-ID tag and a control channel switch is connected in series to the antenna in order to transmit the individual signal when the control channel switch is closed.

7. Control device as in claim 1, wherein the decoder includes a decoder connected to the additional antenna and a control unit that controls the relays corresponding to the individual signals to perform the functions.

8. Control device as in claim 7, wherein the decoder is mounted on an automobile instrument panel.

9. Control device as in claim 1, wherein the additional antenna is mounted on at least one of an automobile instrument panel and a roof in an area adjacent to the steering wheel (1).

10. Control device as in claim 5, wherein a power signal is intermittently transmitted to the antenna so that a capacitor of an RF-ID tag assigned to the actuated pressure switch is charged to activate the RF-ID tag.

11. Control device as in claim 1, wherein the functions selected from the group consisting of horn, flash high-beam headlights, lights on/off, low-beam/high-beam headlights, turn signals left/right, warning flashers, raise/lower left window, windshield wiper front, windshield wiper rear, intermittent windshield wiper, low-speed windshield wiper, and high-speed windshield wiper, are performed corresponding to the individual signals, whereby at least one of the number of actuations and the duration of actuation of the pressure switches are identified and evaluated by the decoder.

12. Control device as in claim 1, wherein the encoder is mounted on a plate connected with the carrier part.
